(19) United States
(12) Patent Application Publication
(10) Pub. No.: US 2004/0227469 A1
(43) Pub. Date: Nov. 18, 2004

(54) Flat panel excimer lamp

(76) Inventors: Karl Schoenbach, Norfolk, VA (US); Wenhui Shi, Sterling, VA (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/684,591

(22) Filed: Oct. 15, 2003

Related U.S. Application Data
(60) Provisional application No. 60/418,590, filed on Oct. 15, 2002.

(51) Int. Cl. H01K 1/62

(52) U.S. Cl. 315/59; 315/72

(57) ABSTRACT

A discharge device generates stable direct current glow discharges at high gas pressures. The discharge device has a flat cathode that does not utilize microhollows, and has an anode containing an arbitrarily shaped opening. A dielectric having a minimum thickness separates the anode and the cathode by a by a distance of less than one millimeter. The discharge device may be included in a discharge chamber for maintaining the device at a predetermined pressure.

This application claims benefit of U.S. Provisional Patent Application No. 60/418,590 filed on Oct. 15, 2002.

### FIELD OF THE INVENTION

The present invention relates to a gas discharge device. More specifically, the present invention relates to a gas discharge device that generates stable direct current glow discharges at high gas pressures, has a flat cathode that does not utilize microhollows, and has an anode containing an arbitrarily shaped opening.

### BACKGROUND OF THE INVENTION

There are a variety of gas discharges that generate plasmas radiating in the Ultraviolet (UV) and Vacuum Ultraviolet (VUV) wavelength range. The most commonly used UV or VUV lamps are mercury lamps, which emit line radiation at 254 nm. Although the efficiency of this radiation is high, approximately 70%, the intensity is relatively low ranging from 40 μW/cm² to 20 mW/cm². High-pressure xenon discharges, which emit over a spectral range from UV, below 300 nm, to the infrared, are much more powerful, but have a low efficiency, approximately 1% or less. As a result, more recently, excimer lamps have become commonly used.

Excimers are molecules, such as rare gas molecules that can only exist in an excited state. Excimers decay rapidly into atoms, thereby emitting radiation in the UV and VUV wavelength ranges. For example, with xenon excimers, the emission wavelength is around 172 nm. Excimer sources utilize the formation of exited molecular complexes (excimers) and the change from the bound excimer state to a repulsive ground state. To generate excimer radiation, two requirements have to be met. First, the electron energy distribution needs a defined amount of electrons with energies larger than the excitation energy of the excimer gas atoms. Second, the pressure must be on the order of one atmosphere or higher. Nonequilibrium plasmas can fulfill these requirements.

Generation of nonequilibrium plasma is possible by operation at high-electric fields for a sufficiently short duration, whereby thermalization of the plasma is prevented. Nonequilibrium plasmas are also generated by operation in a small volume, for example, to the cathode fall of a gas discharge. Conventional excimer lamps are based on the concept of silent discharges or barrier discharges. These are gas discharges between dielectric covered electrodes. The displacement current can only flow for a short time, charging time of the dielectric, and the discharges are therefore operated in a pulsed mode, with voltages generally exceeding 1 kV. The second concept is found in plasma boundary layers, especially the cathode fall of stable high-pressure discharges, such as corona discharges and high-pressure hollow cathode discharges.

New types of discharges devices, which serve as excimer sources, have recently been developed. For example, microhollow cathode discharges are described generally in an article by Schoenbach et al. “Microhollow Cathode Discharge Excimer Lamps,” Physics of Plasmas 7 (2000), Vol. 5, pp. 2186-2191. These microhollow cathode discharges are direct current or pulsed gas discharges between two electrodes, an anode and a cathode, separated by a dielectric, and containing a microhollow. The microhollow cathode hole typically has dimensions on the order of 100 μm, which is required to achieve stable operation at high atmospheric pressure.

Microhollow cathode discharges are gas discharges between a cathode, which contain a hollow structure, and an arbitrarily shaped anode. As shown in FIG. 1a, a typical microhollow cathode structure 10 consists of a cylindrical hole 12 in a cathode 14, with a ring shaped anode 18, separated by dielectric spacer 16, or the anode 18 could be just a metal pin. As shown in FIG. 1b, a cylindrical opening in a thin cathode layer also qualifies as a microhollow cathode structure.

FIG. 2 illustrates a typical microhollow discharge device. The discharge device includes a cathode 20 and an anode 22 mounted within a discharge chamber 24. The discharge chamber 24 is typically sealed and contains as gas at a prescribed pressure P. In some cases, the discharge chamber 24 may have an opening to permit gas flow or to permit passage of a charged particle beam. The discharge chamber 24 maintains the pressure P between anode 22 and cathode 20. Power source 28 is connected to cathode 20 and anode 22 supplies electrical energy to the discharge device.

Cathode 20 comprises an electrically conductive material having one or more microhollows 201. A plurality of microhollows 201 are formed on surface 221 of cathode 20. Dielectric 230 is located on surface 221. Each of the microhollows 201 has a diameter D. The diameter D is defined as the diameter of a cross-section of the microhollow in a plane parallel to surface 221 and perpendicular to a longitudinal axis 224 of microhollow 201.

When operating these discharges in for example, xenon or argon, it was noticed that the discharge plasma, with increasing current, extended beyond the microhole and began to cover the plane area of the cathode surrounding the microhollow. Applications of these DC excimer lamps are in UV polymerization, photolithography, photochemistry, photo-deposition, photo annealing, pollution control, lighting, and many more. However large area lamps require large numbers of microhollows. Although this can be done through laser drilling, the cost of this method becomes an issue when mass production of such lamps is considered.

### SUMMARY OF THE INVENTION

The present invention presents a novel source of excimer radiation. The present invention has all the advantages of microhollow cathode discharges, but is much easier to fabricate and allows the generation of large area flat panel excimer lamps at low cost. The present invention is based on a new type of dc gas discharge, which can be powered by AC, DC or pulsed.

### BRIEF DESCRIPTION OF THE DRAWINGS

FIGS. 1a and 1b illustrate a typical microhollow structure according to the prior art;

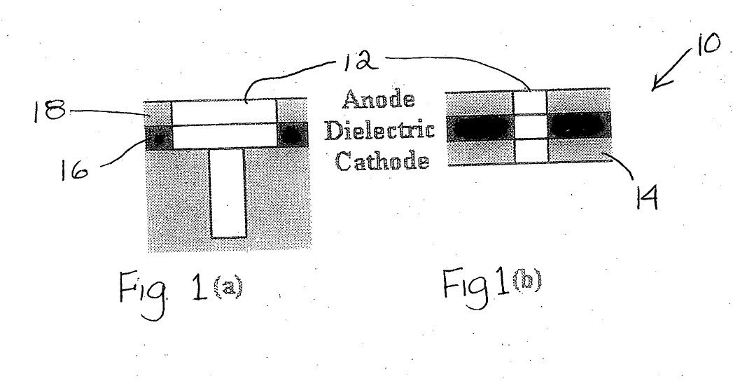

FIG. 2 illustrates a schematic diagram of a discharge device according to the prior art;

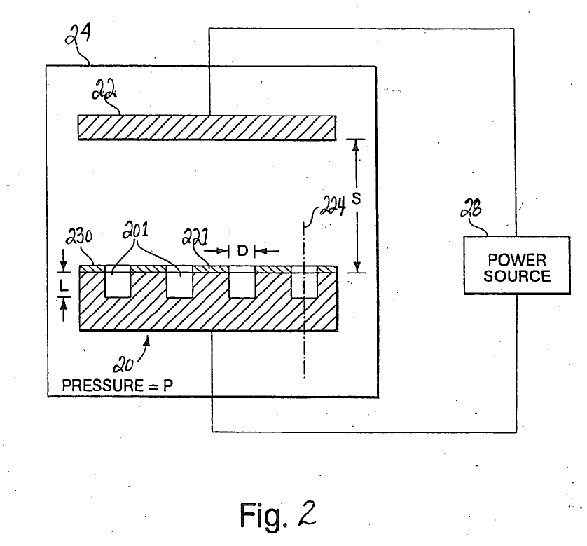

FIG. 3 illustrates a cross-section view of the electrode geometry according to a preferred embodiment of the present invention;

FIG. 4 illustrates a graph of the current-voltage characteristics of the discharges in xenon with pressure as a variable parameter;

FIG. 5 illustrates a cross-section view of the plasma in the circular opening at a pressure of 200 Torr in xenon with increasing current. Shown is the transition into the abnormal glow mode with increasing homogeneity of the optical emission;

FIG. 6 illustrates a simplified schematic drawing of an excimer lamp with slit-shaped cathode areas. As shown, the radiation is emitted from the plasma between the anodes;

FIG. 7 illustrates an alternative electrode geometry according to a preferred embodiment of the present invention;

FIG. 8 illustrates a schematic diagram of a discharge device according to a preferred embodiment of the present invention.

### DETAILED DESCRIPTION OF THE INVENTION

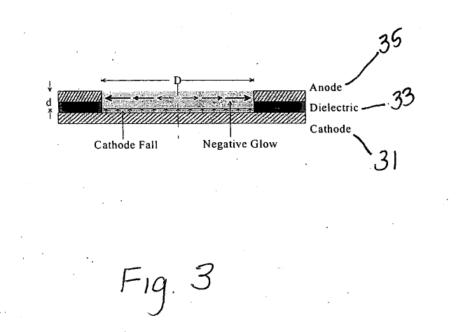

FIG. 3 shows a cross-section of a preferred embodiment of an electrode configuration according to the present invention. The base electrode serves as cathode 31 and the cathode material may be a foil or a slab of metal. The metal cathode preferably has a thickness varying between 100 micrometers and one millimeter. Generally, molybdenum is used as the cathode material because of its high melting temperature, but any other metal could also be used. Additionally, semiconductors with high conductivity may be used as cathode material. The anode 35 is generally of the same material as the cathode 31, and the anode thickness may also vary between 100 micrometers and one millimeter. The anode 35 is separated from the cathode 31 by a dielectric 33. In the present invention, alumina is used as a dielectric, but any other similar material may be used as dielectric. The gas itself may also serve as a dielectric, as long as the anode is held in place at a given distance from the cathode.

The anode is separated from the cathode by a small distance of less than one millimeter. This distance should be as small as possible, but sufficient to hold the initiation and sustaining voltage of the discharge without suffering electrical breakdown. In a preferred embodiment, the alumina layer dielectric 33 is approximately 100 micrometers to one millimeter. A minimum thickness is determined by the hold-off voltage during ignition. The anode 35 and the dielectric 33 have openings that may have any shape, such as circular, with diameters measurements in the mm range. The opening of the dielectric is shown here as preferably being the same size diameter D as that of the anode. The diameter D is in the range of fractions of millimeters to one millimeter.

In operation, when a voltage is applied between cathode 31 and anode 35, plasma discharge is formed between the two electrodes, which carry a current that is dependent on the applied voltage and the gas pressure. This discharge is termed by the inventors of the present invention as cathode boundary layer (CBL) discharge and is a novel type of high-pressure glow discharge, which is restricted to the cathode fall and negative glow, with the negative glow serving as a “virtual” anode. The plasma in the negative glow region provides a radial current path to the anode.

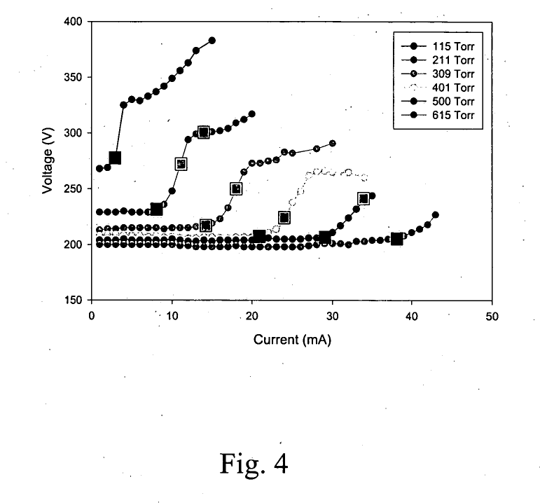

The current voltage characteristics are shown in FIG. 4, for a 3.5 mm opening in the anode at pressures between 115 torr and 615 torr. For example, for rare gases such as xenon, FIG. 4 shows the dependence of the current flowing from anode 35 to the cathode 31 for a voltage applied between anode 35 and cathode 31 for direct current operation and at different pressures.

The current-voltage I-V characteristic shown are for low currents flat. The flat part of the V-I characteristics corresponds to a normal glow discharge. At this point, the voltage increases with current. This discharge mode is characterized by emission patterns in the lower current range and becomes homogeneous at higher currents. As shown, at a particular current, the voltage begins to rise with current, first with a large slope, dV/dl, then with smaller rate of voltage rise. This latter phase corresponds to the onset and the sustainment of an abnormal glow discharge. The positive slope of the current voltage characteristics indicates that the discharge is stable. In this range of operation, the discharges behave like resistors, which means the discharges can be placed in parallel without individual ballast resistors. Any large area lamp may be operated in a current range which shows this positive slope. For example, at a pressure of 309 torr, the current ranges approximately from 16 mA to 30 mA.

Although xenon is illustrated, any other rare gas, such as argon, and rare gas-halide gas mixtures, which generate excimer radiation can be used. Even non-excimer gases and gas mixtures, such as nitrogen, oxygen, and air might be useful in generating large area plasma and light sources with this electrode geometry. Although a 3.5 mm anode is illustrated, the anode may be anywhere from 0.1 mm to 10 mm in diameter. Additionally, although the pressure range indicated is from 115 torr to 615 torr, the pressure may range from 10 torr to 1000 torr.

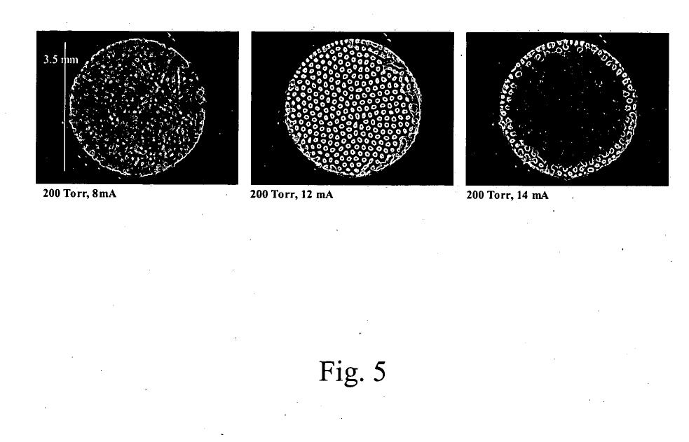

Observations have shown that the discharge plasma, when the discharge enters the abnormal glow mode, extends to the physical boundaries of the open cathode space. This is an indication of the transition from a normal to an abnormal glow discharge. During the transition into a stable abnormal glow, which is characterized by a slow increase in voltage with current, the plasma forms patterns, which indicate self-organization. A set of these patterns is shown in FIG. 5 for increasing current at a pressure of 200 torr in xenon.

FIG. 5 shows images of the plasma observed in the visible spectrum. With increasing current, the homogeneity of the plasma increases and the pattern disappears. The optimum operation for high excimer efficiency is at the transition point from patterned discharge to homogeneous discharge.

As shown in FIG. 5, when the discharge enters the current-voltage range with smaller slope, these patterns merge and homogeneous plasma is formed, which covers the entire area of the cathode. Although these pictures have been taken in the visible wavelength range, images in the VUV wavelength at 172 nm exhibit the same pattern. This means that the plasma serves as a homogeneous excimer emitter.

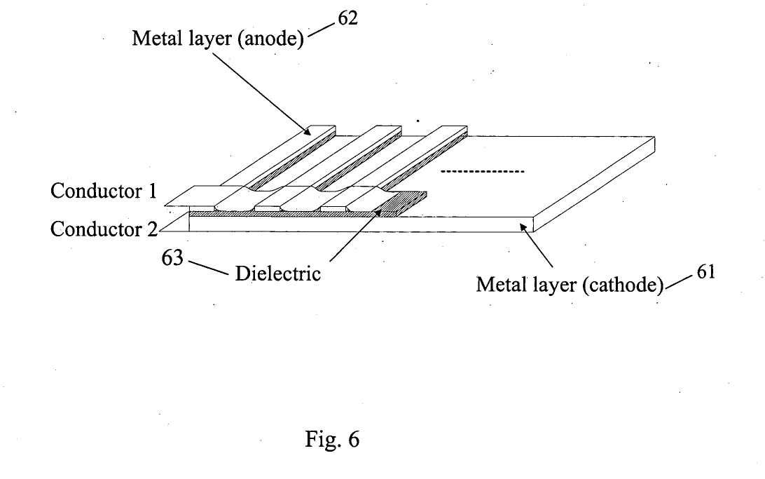

FIG. 6 illustrates a preferred embodiment of the electrode system according to the present invention. As shown in FIG. 6, The base consists of metal cathode layer 61, preferably a refractory metal such as molybdenum with a thickness, which is determined by mechanical stability considerations, and possibly thermal considerations. Cathode layer 61 may also serve as a heat sink. A thin layer dielectric layer 63 with openings is placed on top of cathode layer 61. The anode 62 may be slit-shaped, and are preferably connected by one conducting foil, or wire conductor 1. The cathode is a metal plate or metal foil conductor 2.

This structure is advantageous because the discharges can be run in parallel without needing to stabilize each one independently.

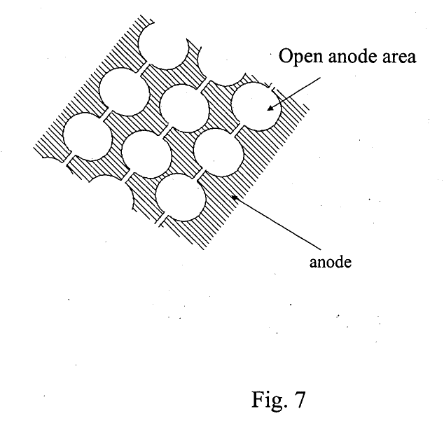

FIG. 7 illustrates an alternate construction of the electrode geometry of the present invention. As shown, the openings are circular instead of slit-shaped. However, these geometries are just examples, there are many other possible configurations as long as the anode is electrically connected. This structure provides preferably one electrical connector to all anodes, rather than many electrical leads to individual anodes.

Any of these geometries allow the use of masks to generate patterns over large areas (>cm²), and consequently allow mass production by using well known coating techniques, such as plasma spraying, plasma deposition techniques, spinning, and any other known coating technique.

Electrical access may be achieved as shown in FIG. 6. Conductors 1 and 2 are connected to the anode and cathode, respectively. Since the individual discharges operate in an abnormal glow mode, the system of the present invention is self-stabilizing. Therefore, individual ballast resistors are not required. The electrode system may be connected to a DC power supply in a manner such that the positive polarity lead is connected to the anode or upper electrode. Sustaining voltages are between 150 and 500 V. For xenon discharges, the voltage is 250 V, when operated in the abnormal glow mode at a pressure of 500 torr.

Instead of using DC power the system may also be powered AC voltage or rf. In the case of AC voltage, the plasma may be generated through one half wave cycle of the AC voltage, rather than through both half wave cycles.

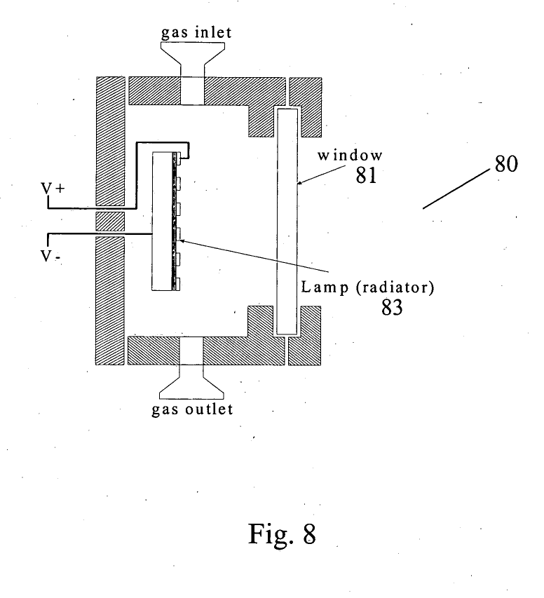

As shown in FIG. 8, the electrodes, are preferably placed in a discharge housing chamber 80, which is filled with an excimer gas, such as xenon. The electrode system of the present invention is placed in a discharge chamber as shown in FIG. 8. The gas pressure is generally in the 100 torr range, but it could be as low as 10 Torr and as high as several atmospheres. The discharge housing chamber includes feed-throughs for the electrical connection, as shown. In order to deliver light or allow the radiation to pass, which is generated on the surface of the cathode (radiator) to the object, a window 81 is included in front of the radiator or lamp 83. The window material may be selected according to the emitted wavelength. For example, for ultraviolet light, ordinary glass is not transparent. The window material therefore would need to be high quality material, such as quartz.

Since the gas may become contaminated with time, it would need to be replenished, using gas inlets and outlets. However, it might also be possible to use sealed systems, where certain getter material will be used to decontaminate the gas.

In a test operation, in xenon the optimum pressure for excimer emission (highest efficiency) is approximately 500 Torr. The current density is for the abnormal glow mode 35 mA/area of the plasma emitter. For a 3.5 diameter the area is 0.096 cm². The current density is consequently 0.36 A/cm². The power density is then given by the voltage of 250 V times the current density as 91 W/ cm². A xenon excimer lamp based on this principle would for each square centimeter emitting plasma surface between the anode panels, require 90 W, a power comparable to that of lamps used for lighting. The UV output at 172 nm, assuming an efficiency of 10% would be 9 W. With 9 W/ cm² such a lamp would provide a UV power density which exceeds any commercial excimer lamp by orders of magnitude.

Such high emission densities allow for the production of miniature UV lamps, for example for bacterial decontamination drinking water in homes, where such a small source could easily be integrated in a drinking water purification system. Also, for commercial application, higher emission density allows higher speed in using such lamps for manufacturing, such as curing of coatings.

The electrode system of the present invention does not need to be planar. It could be shaped such that optimum irradiation conditions are achieved. It could, for example be shaped as a cylinder and placed at the inside of a tube. In this geometry, optimum irradiation of liquid and gas flowing through the tube is obtained. Such a geometry could be used, e.g. for decontamination of liquids or gases.

The discharge housing chamber 80 may have any desired size and shape. Typically, the discharge housing chamber 80 is sealed to maintain pressure P in the discharge region. The discharge housing chamber 80 may be fabricated, at least in part, of a material that transmits radiation generated by the discharge. Thus, for example, the discharge housing chamber 80 may be fabricated of a light-transmissive material, such as glass or quartz, or may have a radiation-transmissive window. In other embodiments, the discharge housing chamber 80 may be configured such that gas at pressure P flows through the discharge region.

While the description refers to preferred embodiments, it will be obvious to one of ordinary skill in the art that various changes and modifications may be made therein without departing from the scope of the invention.

What is claimed is:

1. A discharge device comprising:
a discharge chamber containing a gas at a predetermined pressure;
a flat cathode mounted within said chamber;
an anode mounted within the said chamber, said anode having an opening of a arbitrary shape;
a dielectric layer located between the cathode and the anode, said dielectric layer having substantially the same shaped opening as said anode and located at the same position; and
a means for generating a voltage and current such the device operates in the abnormal glow mode.

2. The discharge device according to claim 1 wherein a plasma layer which is limited by the size of the dielectric is generated on top of the cathode dielectric, and carries the current from the cathode surface transversely to the anode.

3. The discharge device according to claim 1 wherein the anode and the cathode are separated by a distance of less that one millimeter.

4. The discharge device according to claim 2 wherein said plasma layer is a cathode boundary layer discharge.

5. A light source comprising:
a sealed chamber containing a gas at a predetermined pressure;
a flat cathode mounted within said chamber;
an anode mounted within the said chamber, said anode having an opening of a arbitrary shape;
a dielectric layer located between the cathode and the anode, said dielectric layer having substantially the same shaped opening as said anode and located at the same position; and
a means for generating a voltage and current such the device operates in the abnormal glow mode.

6. The light source according to claim 5 wherein a plasma layer which is limited by the size of the dielectric is generated on top of the cathode dielectric, and carries the current from the cathode surface transversely to the anode.

7. The light source according to claim 5 wherein the anode and the cathode are separated by a distance of less that one millimeter.

8. The light source according to claim 6 wherein said plasma layer is a cathode boundary layer discharge.

9. A radiation source comprising:
a sealed chamber containing a gas at a predetermined pressure;
a flat cathode mounted within said chamber;
an anode mounted within the said chamber, said anode having an opening of a arbitrary shape;
a dielectric layer located between the cathode and the anode, said dielectric layer having substantially the same shaped opening as said anode and located at the same position; and
a means for generating a voltage and current such the device operates in the abnormal glow mode.

10. The light source according to claim 9 wherein a plasma layer which is limited by the size of the dielectric is generated on top of the cathode dielectric, and carries the current from the cathode surface transversely to the anode.

11. The light source according to claim 9 wherein the anode and the cathode are separated by a distance of less that one millimeter.

12. The light source according to claim 10 wherein said plasma layer is a cathode boundary layer discharge.
